(19) United States
(12) Patent Application Publication
(10) Pub. No.: US 2015/0341361 A1
(43) Pub. Date: Nov. 26, 2015

(54) Controlling a Mobile Device in a Telecommunications Network

(71) Applicants: Koninklijke KPN N.V., The Hague (NL); Nederlandse Organisatie voor Toegepast-Natuurweten schappelijk Onderzoek TNO, s-Gravenhage (NL)

(72) Inventors: Frank Fransen, Zuidhorn (NL); Sander De Kievit, Leiden (NL)

(73) Assignees: Koninklijke KPN N.V., The Hague (NL); Nederlandse Organisatie voor Toegepast-Natuurweten schappelijk Onderzoek TNO, s-Gravenhage (NL)

(21) Appl. No.: 14/651,039

(22) PCT Filed: Dec. 17, 2013
(86) PCT No.: PCT/EP2013/076845

§ 371 Date: Jun. 10, 2015

(30) Foreign Application Priority Data
Dec. 18, 2012 (EP) 12197659.1

(51) Int. Cl. H04L 29/06; H04W 12/00

(52) U.S. Cl. CPC H04L 63/10; H04W 12/00; H04L 63/1416

(57) ABSTRACT

A system is described to control a mobile telecommunication device within a telecommunications network, when the mobile device is suspected of being, or has been found to be, infected by malicious software or viruses causing it to behave maliciously or aggressively within the network. The telecommunications network is arranged to identify the telecommunication device and limit the communication between the mobile telecommunication device and the telecommunications network. This may mean limiting the bandwidth of the bearer between the mobile telecommunications device and the telecommunications network or may mean limiting the communications between the mobile telecommunications device and a specific location. In further embodiments the telecommunications network quarantines the identified device by either transferring an attachment of the mobile telecommunications device to a second network, or, maintaining a list of devices and adding the identified mobile telecommunications device to the list.

### BACKGROUND TO THE INVENTION

The invention relates to a system arranged to control a mobile telecommunication device within a telecommunications network.

Telecommunications networks provide radio telecommunication to users of mobile devices, typically according to agreed and standardised radio protocols, for example GSM, UTMS and LTE as would be known by the skilled person.

Mobile telecommunications devices are common and include mobile phones and in particular smartphones, tablet devices and other handheld computer devices, handheld personal assistants, and even communication devices situated in vehicles. All can provide users with telecommunication with each other and with access to the internet while moving around.

Access to the internet exposes devices to malware and malicious applications that may be downloaded, accidentally or otherwise, onto the mobile device from the internet. Typically, and often because of their smaller size and memory capacity, mobile telecommunications devices do not contain security features which are as stringent as those available for desk computers and other large devices with internet access. As such, these smaller mobile telecommunications devices are vulnerable to infection and attack by malware and malicious applications, which will typically infect the application processor of a mobile device. But because mobile telecommunications devices are also typically in direct contact with a radio telecommunications network the telecommunications network itself is vulnerable to attack from any malware or malicious applications residing on the mobile devices. A device infected with malicious software can be forced to overload the network, send out spam, request the download of too much data, continuously perform attach and detach to the network and generally take up network resources which could be used elsewhere. Furthermore, while attached to the network such devices can further spread the malware that resides upon them to other mobile devices.

Previous methods to protect a telecommunications network from mobile device behaviour have sometimes focused on non-malicious device behaviour, such as congestion. For example, EP 2 096 884 describes a method of allowing access to a network by a device and describes use of a back off timer when the network is congested. Previous methods have also focused on methods which are applied entirely within the mobile handset itself. For example, “Taming Mr Hayes: Mitigating signaling based attacks on smartphones”, IEEE/IFIP International Conference on Dependable Systems and Networks (DSN 2012), 2012, dsn, pp. 1-12, Collin Mulliner, Steffen Liebergeld, Matthias Lange, Jean-Pierre Seifert, describes a method of protecting a network from actions of a mobile phone by controlling the mobile phone from within. Here a method is proposed to detect aberrant or malicious behaviour from within the application processor of the mobile phone itself using a virtual partition of the application processor within the mobile.

A disadvantage of the described method is that the subsequent control of the phone, after malicious behaviour has been detected, is directed from inside the mobile device itself. But if the mobile device has been infected with malware there can be no real certainty that either the detection method or the subsequent control of device behaviour can be trusted. In operation of the method an infected mobile phone polices itself but the telecommunications network with which the phone is attached cannot be sure that the mobile phone can be trusted.

Other solutions include forcing detachment of the device, but this may simply cause the device to try to attach again, thus causing more signalling within the network and maintaining an attachment between the infected device and the network. Alternatively the network may release any bearers that the device might have, but this might cause the device to go into emergency mode in which case it maintains a connection to the network. The network could instruct, or force, the device to enter into emergency mode, but this would rely on the device itself which since it is infected possibly cannot be trusted. Alternatively, the network could change the subscription of the device, but this is burdensome.

It is a problem to protect the network against attacks from a mobile telecommunications device infected with malware or a malicious application.

### SUMMARY OF THE INVENTION

The invention is described in the claims.

A system is provided which is arranged to control a mobile telecommunication device within a telecommunications network. The system comprises a mobile telecommunications device and a telecommunications network arranged to allow communication with each other. The telecommunications network is arranged to identify the telecommunication device and limit the communication between the mobile telecommunication device and the telecommunications network.

This solves the problem of how to protect the network from attacks by reducing the possibilities for the infected mobile device to launch an attack against the network. By identifying the mobile device and limiting the communication between it and the network the network can ensure that any attacks launched by the device are slowed down, or otherwise reduced in intensity. Typically the telecommunications network can limit communication by limiting the rate at which data is transmitted to the mobile device, for example by limiting the Maximum bit rate (MBR) of the data being transferred to the mobile device.

In an advantageous embodiment the limiting of the communication between the mobile device and the network is performed by the telecommunications network limiting the bandwidth of the bearer between the mobile telecommunications device and the telecommunications network. This limits the impact of the malicious behaviour and prevents overload of the network but without alerting the mobile that the malicious behaviour has been detected.

In an alternative advantageous embodiment the limiting of the communication between the mobile device and the network is performed by the telecommunications network identifying a location which can be accessed via the telecommunications network and limiting the communications between the mobile telecommunications device and the location. In a particularly advantageous embodiment the location is an IP address, accessible through the telecommunications network.

In a further advantageous embodiment where communication between the mobile device and the telecommunications network is limited, the network identifies a type of communication between the mobile telecommunications device and the telecommunications network and to limits the type of communication. This allows the network to reduce the effects of malicious software where it causes a particular type of behaviour in the device, for example botnet, spam or ‘keep alive’ messages, or the downloading of a particular type of file. For example the type of communication which is limited could be a video data stream. This would reduce, for example, the effects of the malicious software where it causes downloading of large amounts of data by downloading video streams.

Detection of malicious behaviour typically occurs in the core network, for example at the serving gateway or the PDN gateway, for example in a 4G network, but in an advantageous embodiment the limiting of communication, according to the invention, occurs at a base station in the telecommunications network. For example this could be at an eNodeB. This has the advantage that control of behaviour of the identified mobile device occurs at the earliest point at which the device comes into contact with the network.

In a particularly advantageous embodiment the telecommunications network is arranged into first and second networks and the identification of the mobile telecommunications device occurs in the first network, the main network. Once a mobile device has been identified the first network transfers handling of the mobile telecommunications device to the second network. This allows the network, or rather the first network, which maintains service across a geographical area and has responsibilities to other customers, to quarantine an identified mobile device. In this case the network, or first network, may include a ghost network, a copy or facsimile of the first network, for example a virtual network within the first network, comprising servers and other computational facilities which mirror, or replicate, the functions of the first network. An infected mobile is then passed into this network, which might typically be smaller than the first network both in size and in computing power, where it is handled and where calls to and from the mobile can be processed. However, the mobile device cannot tell it is being handled by a second network, and therefore any malicious or controlling software on, or connected to the mobile device, cannot be alerted to the fact that the device has been identified, but the device is now isolated from the body of other devices attached to the first network and the chance that it can infect them, or draw disruptively on resources in the first network, is considerably reduced. The use of a second, quarantine, network reduces any overload, or chance of overload, of the main network. In a further advantage the network can easily keep track of which devices have been identified as being infected, because these are the devices transferred to the second network. The sending of an attachment or current call through to quarantine network is advantageously performed at the level of the MME in a telecommunications network.

The use of a second network has the further advantage that in the event that malware on mobile devices is controlled by a malicious entity controlling a large number of infected mobile devices and perhaps controlling them as a unity, the network can effectively control or close down all infected devices by performing actions within the quarantine network. The network can act swiftly to, for example, close down signalling in the quarantine network without this affecting operation of the rest of the network, thereby saving the network from combined malicious action while maintaining service to normal and non-infected devices attached to the network. This has the further advantage that the network can perform an emergency close down of, or suspension of service to, all infected devices by closing off the quarantine network.

In an alternative embodiment the telecommunications network maintains a list of devices and is arranged to add the identified mobile telecommunications device to the list. This is a simple method which allows the network to keep track of devices which have been identified as being infected, or possibly infected, by malware or malicious software. It is relatively simple for the network to check every time a mobile device tries to attach if the mobile is on the list. The list can be maintained at the eNodeB, for example at each eNodeB in the network.

The invention is of particular use when the telecommunications network is arranged to detect the behaviour of the mobile telecommunications device, and in particular where the behaviour indicates that the mobile telecommunication device is behaving abnormally within the telecommunications network. When the telecommunications network detects such behaviour it identifies the mobile device in which the behaviour is occurring and limits communication between itself and that device, according to the invention.

The invention has the advantage that it allows the network to handle or control the device while keeping the device attached, because if the network detaches the device completely the user, or malware on the device, becomes suspicious.

Detection of malicious behaviour can be achieved according to the following method.

A system can be used for detecting behaviour of a mobile telecommunications device in a telecommunications network. Typically this behaviour will be malicious, or abnormal, behaviour. The system includes a telecommunications network configured to identify at least one mobile telecommunications device and to receive signals from the mobile telecommunications device and further to process the signals into data streams. The data streams include data of a first type arranged to cause an event of a first type within the telecommunications network. The network is arranged to monitor an occurrence in the data streams of the data of the first type and is arranged to register when the occurrence exceeds a level indicating acceptable behaviour of the mobile telecommunications device in the telecommunications network.

This system identifies malicious, or abnormal, behaviour in a mobile device, but identifies it from within the telecommunications network itself. This is done by monitoring the data streams, or transfers of data, which occur in the network due to the interaction between the network and the mobile. This data is monitored for excessive occurrences of particular signals.

Malware resident on a mobile device may cause that device to indulge in malicious behaviour, which is typically anything that uses up network resources without being for an express user intention. Typically it is anything which uses up network resources but without resulting in a benefit for the user or for the device. For example, a user of a mobile device may wish to download a video to watch on the device. This will use up resources but the use of resources in this case is time limited and in any event, once the video is downloaded the user spends time watching the video and while doing so is unlikely to download other videos or perform other tasks. Malware, however, may be programmed to download videos continuously, and this uses excessive network resources. In an alternative example, malware may be programmed to continuously perform attach and detach of the mobile device onto the network. This will use excessive network resources because the network will try to authenticate the mobile device every time the device attaches. The continuous attach and detach however does not result in an advantage for either the user or the mobile device. In an alternative example, malware may be programmed to manipulate signal level reports used by the network for handover decisions. The mobile device continuously measures the signal levels from base stations in the surrounding cells and reports the signal levels to the network. The network uses this, and other information, to device whether or not to handover the communication with the mobile device to a different base station than the one that is currently serving the mobile device. Malware could be programmed to manipulate the measurement reports in such a way that a very large number of handovers takes place, which uses excessive network resources. In an alternative example the malware may be programmed to force the mobile device which carries the malware to continuously request call forwarding. When a request for call forwarding is made the device requests the network to forward incoming calls to a second number. The continuous making of this request will use up network resources. In an alternative example the malware may constantly request the setting up of bearers, and in particular new bearers, between the device and the network. Again, this uses up network resources. In an alternative example the malware may force the mobile device which carries the malware to continuously make requests for service without using the proffered services. These requests may be for any kind of service typically provided by the telecommunications network but it wastes network resources when the continuous requests for service do not result in a provided service which benefits either the user or the mobile device making the request.

In all these examples an exchange of data occurs between the mobile device and the telecommunications network but also further within the telecommunications network itself. When the mobile device transmits signals to the telecommunications network they are received in a base station and processed into data streams internal to the telecommunications network. For example, if an attach request is made by a mobile device then the telecommunication network which receives the attach request makes an attempt to authenticate the mobile device. This results in data streams, or signals, being sent between, for example in the case of a UMTS network, the radio network controller RNC, the mobile switching centre MSC, the Home Location Register HLR, and the Authentication Centre AuC, as would be known by the skilled person. As would also be known by the skilled person, other malicious behaviours described would also result in signalling, or data streams, transmitted not just between the device and the network but also within the network itself.

The network can therefore detect malicious behaviour by monitoring the occurrence in the data streams in the network of data of a first type, typically a predetermined type which represents some interaction in the network between network devices for the normal processing of signals. Further the network registers when this occurrence exceeds a level which indicates acceptable behaviour of the mobile telecommunications device in the telecommunications network. In other words, the network detects malicious behaviour by monitoring for, and detecting, the incidence of various types of data steams within the network itself and registering when the occurrence is too high.

For example, in order to detect the malicious behaviour in which a device continuously attempts to attach and detach the network may count the number of times the Mobile Switching Centre, MSC, is caused to request authentication of the device at the Authentication Centre AuC, or alternatively count the number of times the Authentication Centre AuC signals back a reply.

In a particularly advantageous embodiment the detection of data steams is performed in the core network, and in particular in the Mobility Management Entity MME if the network is an LTE network, in the MSC if it is a UMTS or GSM network or the Serving Gateway Support Node SGSN in a GPRS network. In this embodiment the incidence of particular, or predetermined, data streams can be identified in a central location within each respective network. This has the advantage that it reduces the time it takes for the telecommunications network to identify mobile devices which may be infected by malware.

However the occurrence of specific data streams may be detected further back in the network. In an example of this, excessive attach requests may be detected at the AuC by detecting authentication attempts per mobile device. Alternatively, excessive attach requests may be detected by counting at the HLR the number of times the network requests data regarding a particular mobile device.

In certain embodiments detection could be performed in the eNodeB or base station. This has the advantage that detection of malicious behaviour uses fewer network resources. For example, excessive numbers of attach and detach could be detected in the receiving base station. However, a particular disadvantage of performing detection at the base station, for example, occurs when signals from the mobile device arrive in the network through different base stations, and one example of this is when a device is physically moving quickly across base station cells. In such a case no one particular base station, or eNodeB, will necessarily receive the full signalling from the device and therefore no one base station will be able to unambiguously perform detection.

In a particularly advantageous embodiment the network counts the occurrence of particular data signals when their rate of occurrence exceeds a predetermined temporal rate. For example, if the network is monitoring for the sending of an authentication request to the AuC, the network is arranged to detect when the rate of transmission of authentication requests for a particular mobile exceeds a predetermined threshold and also to count the number of times authentication is then requested, while the rate of authentication requests exceeds the predetermined rate.

In other words the network monitors for, and detects when the frequency of a certain predetermined signal or data occurrence in the data streams becomes too high. The network then proceeds to count the number of occurrences while the rate remains above the predetermined temporal rate.

This particular embodiment is even more advantageous if the network is further arranged to register when the number of detected occurrences itself exceeds a predetermined threshold. In our example this would mean that the network registers when the number of authentication requests exceeds a certain number, with each authentication request having been received at a rate which is greater than the predetermined temporal rate.

In a further advantageous embodiment, the network can detect if the rate of occurrence of a signal or data event, for example a request for authentication transmitted to the AuC, occurs at or above a predetermined temporal rate by measuring the time elapsed between successive occurrences. In this embodiment the network is arranged to detect the time elapsed between two consecutive authentication requests to the AuC, in our example, and calculate when this elapsed time is less than a predetermined time interval. The data occurrences are deemed to occur at a rate which exceeds the predetermined rate when they occur within the respective predetermined time interval.

In a particularly advantageous example the network includes a counter, C, and is arranged to detect a detectable event, X, which occurs within the network, for example the first instance of an attach, or, the transmission of a request for authentication to the AuC, or, the arrival of signaling in the MME indicating that a handover has taken place, and starts the counter.

The counter then becomes:

C=1

At the same time the network starts a timer. The counter is stored and associated with the mobile device.

If the next detection of X in the network takes place within a predetermined time interval then the counter becomes:

C=2

In an embodiment the timer measures a time t from the first detection of X and in this case the counter is incremented by 1 if the next detection occurs at a time, t<Δ, where Δ is the predetermined time interval. In an alternative embodiment the time at each detection of the event X is registered, the time of the first event, ST, being stored and associated with the mobile device. A timer, T, is started at ST and the counter is incremented if the time of the next detected event X is t where:

t<ST+A

Within this embodiment the value of ST is then replaced by the new time NT at which the second event X was detected.

In both embodiments the counter is incremented again if the following detection of X occurs within the same time interval. In such a case the counter would now register:

C=3

If the counter reaches a predetermined threshold, say Cₙ, in which case the counter becomes:

C=Cₙ

the telecommunications network registers the fact. This may be done by setting a flag, but the skilled person knows that there are alternative methods of registering.

In an alternative embodiment the network registers if the counter exceeds a predetermined threshold. If X is not detected again within the predetermined time interval, the counter goes back to zero.

In an alternative embodiment the network could monitor and count the number of detachments of a particular mobile device.

In an embodiment in which handover is detected, the following further embodiment is particularly advantageous. The network maintains a record of the tracking area of the mobile device and also an indication of when the tracking area changes. This allows the network to know when the device is moving. If the network registers an excessive number of handovers the tracking area information can be used to discount excessive handovers when the device is actually in physically rapid movement.

In a further embodiment the network registers when a device switches frequently between neighbouring bases stations. This is an indication of genuine mala fide behaviour as normally such switches are suppressed by existing handover algorithms to avoid excessive handover of a mobile device that is actually physically situated on the border between two cells.

In an alternative, and particularly advantageous embodiment, the network monitors improbable service request combinations. For example, it is unlikely that a user would request the streaming of five movie downloads in parallel. Equally unlikely is that the user would genuinely attempt to listen to his own voice mail while making a telephone call.

Following detection of malicious behaviour the network can perform several actions. These include: detaching the mobile device; sending a signal to the device to permanently block access to the network; starting a back off timer to stop the mobile device from making another connection request within a certain time period; send a warning message to the owner of the device. In the last example the warning could be transmitted to the mobile device itself, via sms for example, however if the device is infected by malware and cannot be trusted then the network cannot assume any warning message transmitted to the device itself will be seen or heard by the user. Therefore a warning could be transmitted to the user via other channels relying on other data stored for the user, for example by email to a known email address.

In a further advantageous embodiment the network tracks the behaviour of several devices and aggregates the results. In this way malware behaviour can be tracked and monitored across an entire network.

In a further advantageous embodiment the network monitors for the occurrence of data of a second type in the data streams. Typically the data streams that are passed around the network include more than one type of data and in addition to including data of a first type arranged to cause an event of a first type within the telecommunications network, may include data of a second type arranged to cause an event of a second type with the telecommunications network. In a particularly advantageous embodiment the network may monitor for malicious behaviour of a mobile device by monitoring for the occurrence of both data of the first and second type, determining when each exceeds some predetermined threshold. In this case each can exceed a predetermined threshold individually, and the predetermined thresholds can be different or be the same, or, both occurrences can be aggregated and can be compared to a single predetermined threshold together. In an example the network could monitor for data occurrences in the network indicating device attach, as has already been described, but additionally monitor for data occurrences indicating device detach, and only if both occurrences exceed independent predetermined thresholds does the network register that malicious behaviour is occurring. This double measurement, although using extra network resources by effectively counting device behaviour twice, provides the network with a failsafe against accidental registers of malicious continuous attachment due to extraneous other factors within the network, such as error.

In an alternative embodiment, the network could count the occurrence of data of a first type indicating handover, and also count the occurrence of data of a second type indicating change of tracking area.

Further embodiments of the invention are shown in the Figures.

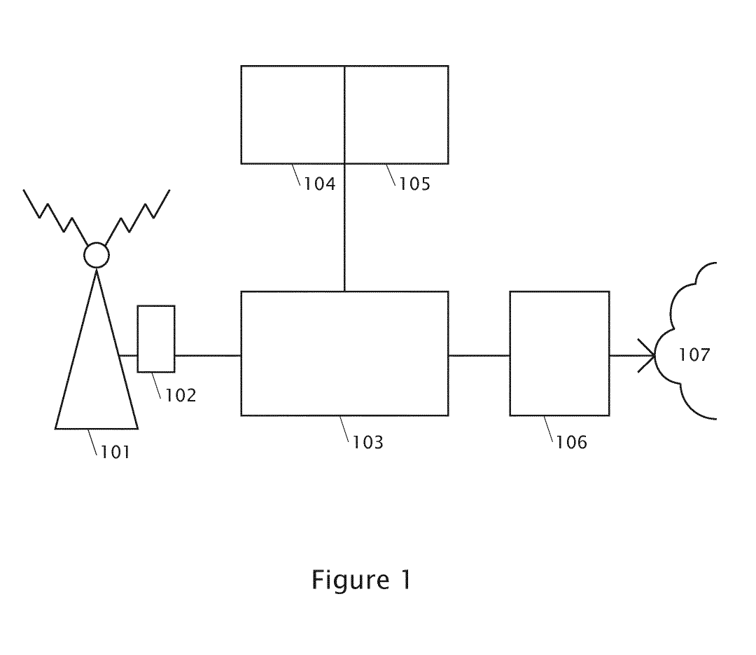

FIG. 1 shows a telecommunications network in which malicious behaviour can be detected.

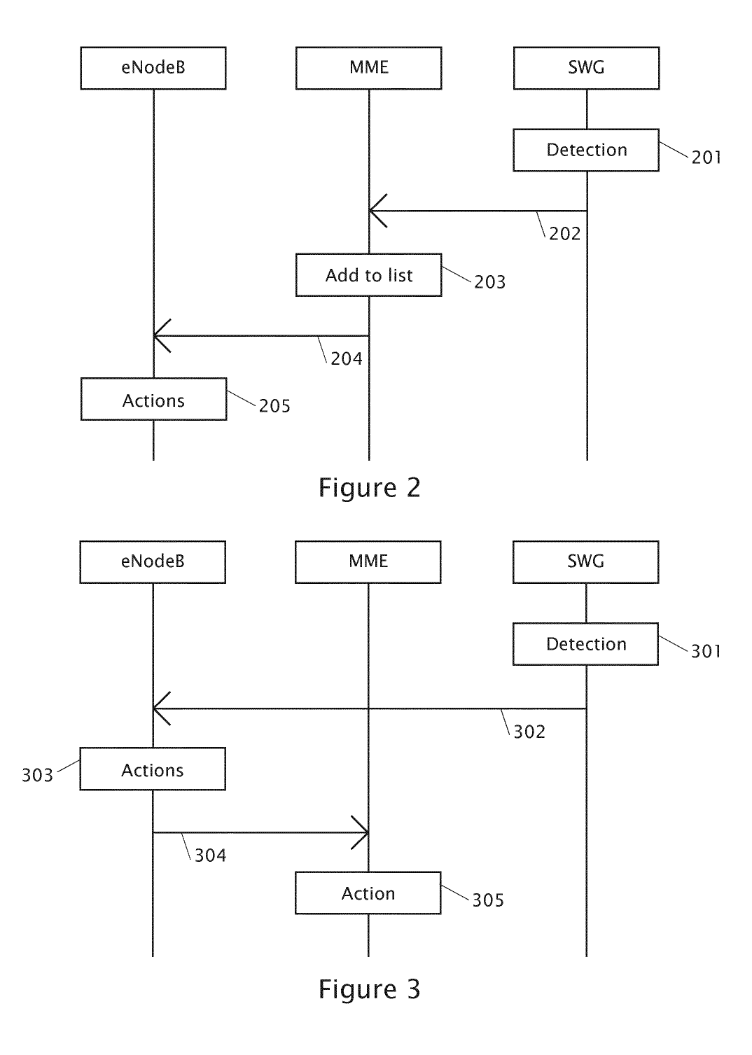

FIG. 2 shows an embodiment of the invention in which signalling within the network goes via an MME.

FIG. 3 shows an embodiment of the invention in which signalling within the network goes straight to an eNodeB.

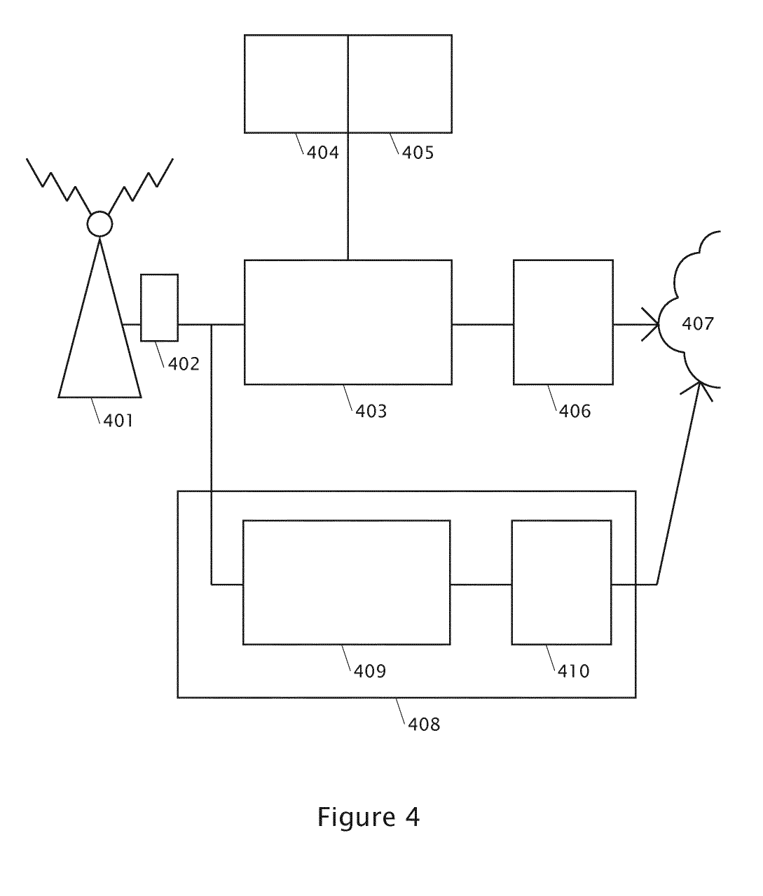

FIG. 4 shows an embodiment of the invention.

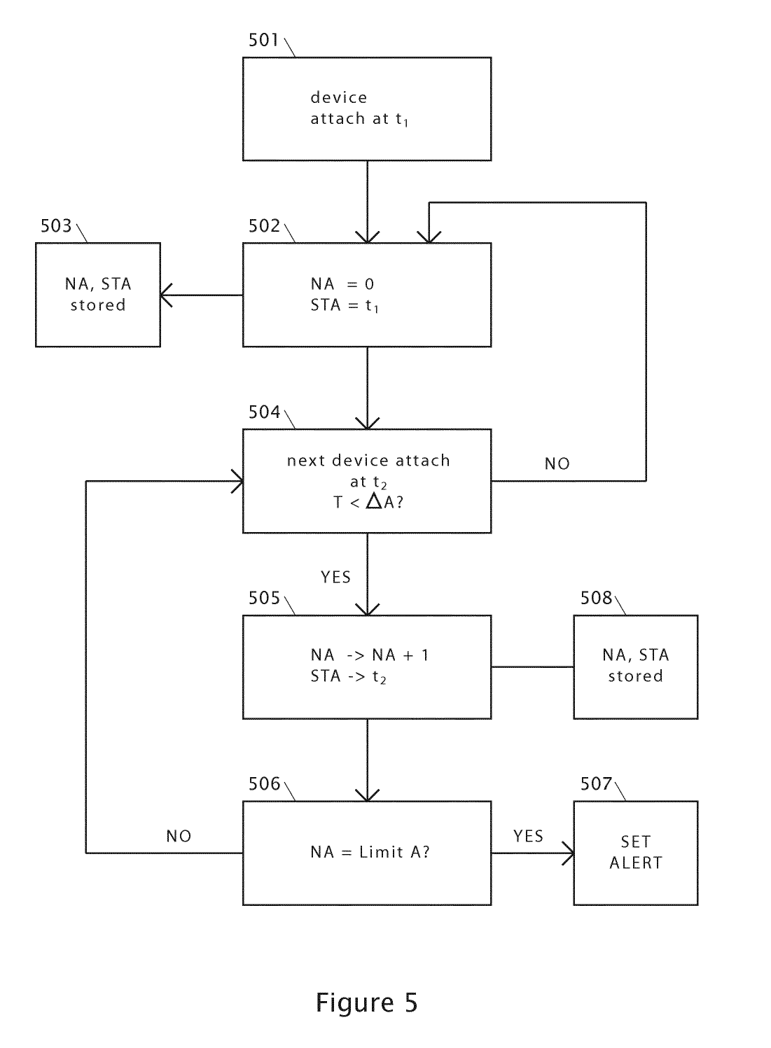

FIG. 5 shows a flow diagram of an embodiment of detection of malicious, or abnormal, behaviour.

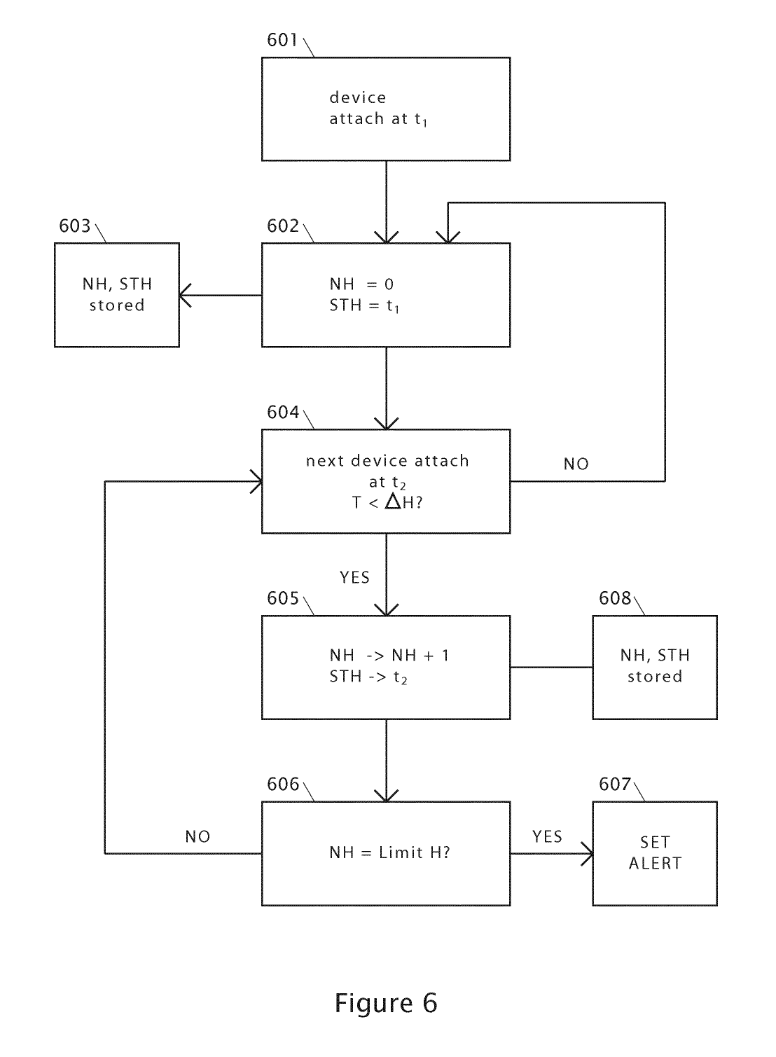

FIG. 6 shows a flow diagram of an embodiment of detection of malicious, or abnormal, behaviour.

FIG. 1 shows a telecommunications network in which malicious behaviour can be detected. As is known by the skilled person there are multiple technologies described by various telecommunication standards that define telecommunications systems. Typically they include the following layout though the skilled person knows and appreciates that there may be small variations and differences in the way systems work.

A telecommunications network includes a transmitter 101. This is usually called a base station, cell tower, or, in an LTE network an eNodeB. The transmitter is controlled by a base station controller 102, though in, for example, a UMTS network this would be a Radio Network Controller 102 and in, for example, an LTE network the control functions of the base station controller 102 may be subsumed into the eNodeB. Radio signals from hand held mobile devices are received at the transmitter 601, processed into signals and transmitted to the core network.

In the case of a GSM or 2G network the signals are passed to a Mobile Switching Centre, MSC, 103, which routes calls. Upon first receiving signal from a mobile it will query the Home Location Register, HLR, 104, which holds data on mobile subscribers to verify if the signal received is from a mobile device which is subscribed to the network. In order to authenticate the mobile device it will use keys held in the Authentication Centre, AuC, 105.

In the case of a UTMS or 3G network the verified and authenticated signals may be routed through a Gateway Support Node 106.

In the case of an LTE or 4G network the signals are passed to a Mobility Management Entity, MME, 103 and the mobile is verified and authenticated at the Home Subscriber Server, HSS, 104/105. Calls are then further routed through a Serving Gateway 106 to a further network 107 which may be the internet.

Malicious behaviour can be performed anywhere in the core network, but can in particular be performed at the Serving Gateway 106.

FIG. 2 shows an example of an embodiment of the invention in which signalling within the network goes via an MME. Here undesired behaviour is detected 201 in a Serving Gateway, SGW, in a network. The Serving Gateway, SGW, sends a detection report 202 to an MME, which adds the identification of the mobile device performing the undesired behaviour to a list 203. The MME sends a detection report 204 to the eNodeB which takes actions 205. The possible actions undertaken by the eNodeB include, but are not limited to, reception and interpretation of the detection report, deciding on countermeasures to be taken and adding the mobile device to a list of identified devices. This list may also include countermeasures to be taken.

In an advantageous embodiment a detection report includes an identification of the mobile device, an indication of the type of behaviour detected and some indication of the countermeasure, for example a possible filter, to apply to the mobile device.

FIG. 3 shows an example of an embodiment of the invention in which signalling within the network goes straight to an eNodeB. Undesired behaviour is detected 301 in a Serving Gateway, SGW, in a network. In this case the Serving Gateway, SGW, sends a detection report 302 directly to an eNodeB, which takes actions 303 including reception and interpretation of the detection report, deciding on countermeasures to be taken, adding the mobile device to a list of identified devices which list may also include countermeasures to be taken, and informing 304 an MME of the countermeasures taken. The MME performs actions 305, including adding the mobile device to a list of such identified devices.

In an advantageous embodiment a detection report includes an identification of the mobile device, an indication of the type of behaviour detected and some indication of the countermeasure, for example a possible filter, to apply to the mobile device.

In an advantageous embodiment the countermeasure report includes an identification of the flagged or otherwise identified mobile device and an indication of the applicable countermeasure.

FIG. 4 shows an embodiment of the invention in which the network comprises a quarantine network 408 in which an identified mobile device can be isolated from the main body of the network and its communication structure. Whereas in the core network signals are passed from a base station or eNodeB 401, with control software 402 and then passed to, for example, an MME 103 before verification and authentication using an HSS 104 and AuC 105, before routing through a Serving Gateway 106 to a further network 107, the network now comprises a further MME, or equivalent structure as would be known to the skilled person, 409 and a further Serving Gateway 410. The HSS and AuC may also be reproduced, however since the mobile device will already have been identified as performing malicious behaviour this may not be necessary and the strength of this embodiment lies in isolating an identified mobile device. Isolation by handling the device through second or sub-network 408 allows the network to protect itself from malicious software controlling the device, allows non-infected devices using the network in a normal manner to be protected and allows the network the possibility of an emergency shutdown of infected devices should that be necessary.

FIG. 5 shows a flow diagram of an embodiment of detection of malicious behaviour suitable for detecting excessive attaches of a mobile device to a telecommunications network. In an advantageous embodiment a device attaches 501 to the network at time t₁ through a base station and the network registers the attach, identifies the mobile device and begins authentication procedures. In parallel with the normal processing of the attach request the network performs the following steps. A counter NA, a start time STA and a timer are initiated 502. Typically the counter will be set to zero and in an advantageous embodiment the timer set to time t₁ registered by the network. The counter value and start time are stored 503 for future reference. The next time an attach is registered for the same device, say at time t₂ the elapsed time T, equal to:

t₂−STA

is compared with a predetermined time interval ΔA 504.

If:

T=ΔA,

or,

T>ΔA,

the counter NA and the timer are cleared, 502.

If:

T<ΔA,

the counter NA is increased by a value of 1 and the value of STA is replaced by the time t₂, 505. NA and STA are again stored 508. In this case the counter value is further compared with a predetermined threshold, LimitA, 506.

If:

NA=LimitA,

an alert is set. If not, the method returns to step 504.

The skilled person will understand there are minor variations which can be made to the embodiment which will still work. For example, the counter could be increased if T is less than or equal to ΔA and only cleared if T is greater than ΔA. Also for example, LimitA could be a value which must be exceeded, in which case an alert flag would be set if NA>LimitA. In another advantageous embodiment a counter could be decremented instead of clearing the counter NA in step 502 if the value of the counter is larger than 0.

As the skilled person will understand, appropriate values for LimitA and the predetermined time interval ΔA will vary depending on the network and the customer base. However, suitable values are ΔA=500 ms and LimitA=10.

The method as described allows a network to detect malicious behaviour in the form of excessive attach requests from an infected mobile and in an advantageous embodiment would be performed in the MSC, Serving Gateway or MME of the network, as appropriate.

FIG. 6 shows a flow diagram of an embodiment of detection of malicious behaviour suitable for detecting excessive handovers of a mobile device in a telecommunications network and in a particularly advantageous embodiment would be performed in the MME of the network, which is informed of handovers before the handover takes place, referred to as an S1-handover, or after the handover has occurred, referred to as an X2-handover.

In order to carry out the method the MME performs the following steps for a group of mobile devices in its area. The group of devices monitored could be the group consisting of all mobile devices in its area, but could also be a sub-group of this group or some other further defined group. For example, the group of mobiles which are monitored could consist, say, of all new mobiles, or of mobiles whose previous activity suggests they might be at risk of infection, for example if they make frequent download requests, or of mobiles which are registered to particular users, says users who frequently change mobiles.

In this advantageous embodiment a device attaches 601 to the network at time t₁ through a base station and the network registers the attach, identifies the mobile device and begins authentication procedures. In parallel with the normal processing of the attach request the network performs the following steps. A counter NH, a start time STH and a timer are initiated 602. Typically the counter will be set to zero and in an advantageous embodiment the timer set to time t₁ registered by the network. The counter value and start time are stored 603 for future reference. The next time an attach is registered by the same device, say at time t₂ the elapsed time T, equal to:

t₂−STH

is compared to a predetermined time interval ΔH 604.

If:

T=ΔH,

or,

T>ΔH,

the counter NH and the timer are cleared, 605.

If:

T<ΔH,

the counter NH is increased by a value of 1 and the value of STH is replaced by the time t₂, 605. NH and STH are again stored 608. In this case the counter value is further compared with a predetermined threshold, LimitH, 606.

If:

NH=LimitH,

an alert is set. If not, the method returns to step 604.

Again, the skilled person will understand there are minor variations which can be made to the embodiment which will still work. For example, the counter could be increased if T is less than or equal to ΔA and only cleared if T is greater than ΔA. Also for example, LimitH could be a value which must be exceeded, in which case an alert flag would be set if NH>LimitH.

The particular advantages of the invention are that a telecommunications network can monitor for malicious activity in mobile devices and identify when a particular device is potentially infected by malware. Although use of the invention requires network resources that would otherwise not be expended, it allows the easy identification of devices which may use up far greater network resources if left unidentified.

As the skilled person will understand, appropriate values for LimitH and the predetermined time interval ΔH will vary depending on the network and the customer base. However, suitable values are ΔH=2 s and LimitH=20.

1. A system arranged to control a mobile telecommunication device within a telecommunications network,
comprising a mobile telecommunications device and a telecommunications network arranged to allow communication with each other,
characterised in that,
the telecommunications network is arranged to identify the telecommunication device and limit the communication between the mobile telecommunication device and the telecommunications network.

2. A system according to claim 1 wherein the telecommunications network is arranged to limit the bandwidth of the bearer between the mobile telecommunications device and the telecommunications network.

3. A system according to claim 1 wherein the telecommunications network is arranged to identify a location which can be accessed via the telecommunications network and wherein the telecommunications network is further arranged to limit the communications between the mobile telecommunications device and the location.

4. A system according to claim 3 wherein the location is an IP address.

5. A system according to claim 1 wherein the telecommunications network is arranged to identify a type of communication between the mobile telecommunications device and the telecommunications network and to limit the type of communication.

6. A system according to claim 5 where the type of communication is a video data stream.

7. A system according to claim 1 wherein limiting of communication occurs at a base station in the telecommunications network.

8. A system according to claim 6 where the base station is an eNodeB.

9. A system according to claim 1 wherein the telecommunications network is arranged into first and second networks, wherein the identification of the mobile telecommunications device occurs in the first network and wherein the first network is arranged to transfer a handling of the mobile telecommunications device to the second network.

10. A system according to claim 1 wherein the telecommunications network is further arranged to maintain a list of devices and is arranged to add the identified mobile telecommunications device to the list.

11. A system according to claim 1 wherein the telecommunications network is further arranged to detect a behaviour of the mobile telecommunications device and is further arranged to identify the telecommunication device when the telecommunications network detects the behaviour.

12. A system according to claim 11 wherein the behaviour indicates that the mobile telecommunication device is behaving abnormally within the telecommunications network.
